(19) United States
(12) Patent Application Publication
(10) Pub. No.: US 2012/0053754 A1
(43) Pub. Date: Mar. 1, 2012

(54) ELECTRONIC COMMUNICATIONS AND CONTROL MODULE

(76) Inventors: Karen Pease, Coralville, IA (US); Jonas Bereisa, JR., Bloomfield Hills, MI (US)

(21) Appl. No.: 12/872,846

(22) Filed: Aug. 31, 2010

(51) Int. Cl. G06F 19/00

(52) U.S. Cl. 701/1

(57) ABSTRACT

The present invention includes a system for controlling a motor vehicle. A combination of hardware and software that is modular, redundant and upgradeable communicates with a plurality of vehicle components. The hardware and software combination also communicates with remote computing resources. The system includes a display in the vehicle. The invention also includes an electronic communications and control module that has hardware and software cooperating to facilitate operation of a motor vehicle by using the protocol layer to translate between the device drivers and other software. The hardware includes several identical, hot-swappable circuit boards and one or more communication devices. Both the software and the hardware of the module are upgradeable. And the module may use communication devices to off load computation or storage for one or more vehicle components onto remote computing resources.

### FIELD OF THE INVENTION

The present invention relates to control modules for vehicles and more particularly to a universal control module for controlling some or all functions of a vehicle.

### BACKGROUND OF THE INVENTION

Every year, new motor vehicles reaching the market pick up more options. Every new device added to a vehicle—from ultrasound back-up obstruction detectors to Blu-ray players with headrest screens to in-dash navigation computers—contains an array of electronics hardware that adds to the vehicle's mass and power consumption. For cars, the wiring harness alone may weigh hundreds of pounds, with electronics consuming six-hundred watts or more. The situation on trucks is similar.

Developing new hardware takes years and presents an evolutionary dead-end: once the purpose it was designed for has been superseded, the whole unit needs to be replaced with a newly engineered device in the next version. And the number of devices expected in a modern motor vehicle for comfort, entertainment, and safety rises every year.

Vehicle owners would love to be able to upgrade their vehicles, but they can't—not easily, at least. This mode of building vehicles leaves them locked into a configuration that makes aftermarket upgrades costly—where possible at all. As a consequence, an owner tends to keep their vehicle as it is throughout the entire ownership period—even if they may decide at a later date that there are other options that they would purchase.

With the ever-increasing part count in motor vehicles, recalls become an ever-growing threat to manufacturers. Increasingly, these recalls will pertain to electronic systems and the need to provide software updates to the electronic systems. Recalls are costly and lead to significant negative PR—putting manufacturers in the unenviable position of choosing between their company's reputation and their customer's safety.

Additional considerations are pushing vehicles toward ever more efficient designs. While a large electronics power drain and mass may be acceptable on large cars or trucks, it can ruin the efficiency of a small, efficient car. Electric vehicles, in particular, will suffer strongly from this mass and parasitic drag.

Combined with competition from emerging manufacturers putting additional constraints on price, automakers are left in an untenable position of needing to produce vehicles with more options that can be quickly brought to market while also being efficient.

The present invention overcomes one or more of these problems.

### SUMMARY OF THE INVENTION

The present invention includes a system for controlling a motor vehicle. A combination of hardware and software that is modular, redundant and upgradeable communicates with a plurality of vehicle components. The hardware and software combination also communicates with remote computing resources. The system usually includes a display in the vehicle.

The invention also includes an electronic communications and control module that has hardware and software cooperating to facilitate operation of a motor vehicle by using the protocol layer to translate between the device drivers and other software. The hardware includes several identical, hot-swappable circuit boards and one or more communication devices. Both the software and the hardware of the module are upgradeable. And the module may use communication devices to off load computation or storage for one or more vehicle components onto remote computing resources.

### BRIEF DESCRIPTION OF THE DRAWINGS

In the drawings:

FIG. 1 shows a schematic layout of one embodiment of a hardware device according to the present invention.

FIG. 2 shows a schematic layout of one embodiment of software according to the present invention.

FIG. 3 shows a portion of one embodiment of the protocol layer.

### DETAILED DESCRIPTION

The present invention centralizes control for a combination of several discrete vehicle components into a single, redundant (and thus failsafe), upgradeable, and network connected system. A centralized control system for a motor vehicle has not previously been possible due to lack of cooperation in the design and construction of motor vehicles. Motor vehicles include consumer and commercial vehicles ranging in size from passenger cars, to vans and trucks, to fright vehicles such as semi-tractor trailers.

Exemplary vehicle components whose control may be centralized include turn signals, brake lights, running lights, headlights, fog lights, interior lights, dashboard displays, heads-up displays, indicator LEDs, brakes, throttle, steering wheel, ignition, gear shifting, garage door openers, digital RF in, audio in, video in, video players, cameras, GPS, magnetometers, accelerometers, tilt sensors, pointing devices, touchscreens, video out, audio out, horns, speakers, radar, ultrasound and laser range finders, data storage, hard disks, antilock brake systems, stability control systems, transmission systems, attention monitoring systems, sensors for crankshaft, wheel speed, door lock, alarm, seatbelt latched, door open, gas cap, charger cap, charger connected, gas connected, airbag, and parking brake, etc., systems for monitoring weather, battery voltage, motor voltage, solar panel voltage, charge port, window position, headrest position, seat position, steering wheel angle, wheel angle, seat rotation, headrest tilt, backrest tilt, seat tilt, corrosion detection, fluid levels, oil, coolant, wiper fluid, fuel type, water in fuel, battery, oil filter, air filter, transmission fluid, oil, fuse, transmission gear, temperature, coolant, inverter, engine, atmospheric pressure, manifold pressure, brake pressure, tire pressure, force, torque, weight, bumper force, battery state, battery current, motor current, charger current, solar panel current, external charger, power locks, brake pressure, component heating, defrosting, heated mirrors, translation, tire management, tire sealant, tire inflation, etc., systems for heating and cooling the vehicle, controlling sunroof, moon roof, power windows, doors, mirrors and locks, windshield wipers, alternator, generator and combinations of the sensors, monitors and systems described above as well as similar devices and functionality that may be found on a vehicle. Some of these vehicle components may be grouped together for ease of administration such as applying common permissions for all safety related systems.

The centralized control system comprises an electronic communication and control module (ECCM) for a vehicle. The ECCM is a modular, redundant and upgradeable multitasking system that integrates all, or a number of, systems and sub-systems on a vehicle used for the operation of the vehicle and/or the comfort of the occupants. The ECCM also is network connected and has the ability to offload computational tasks and data to remote computing platforms through one or more network connections. The offloading ability permits the vehicle to have access to many more computing resources and data storage than space, weight or energy consumption concerns would permit on the vehicle.

The ECCM would find use in all kinds of motorized vehicles, including trucks and cars, with the ECCM being particularly useful in passenger vehicles. In a preferred embodiment, the ECCM is utilized in passenger vehicles that use a low amount of fuel and/or electricity per mile.

The ECCM includes hardware and software. The modularity of the ECCM is manifested in both the ECCM hardware and software. For example, as discussed below, circuit boards may be replaced and computation modules may be used to introduce new or upgraded software into the system. Likewise, redundancy may be found in both ECCM hardware and software. For example, multiple circuit boards and multiple computation modules may be used in monitoring a vehicle's systems.

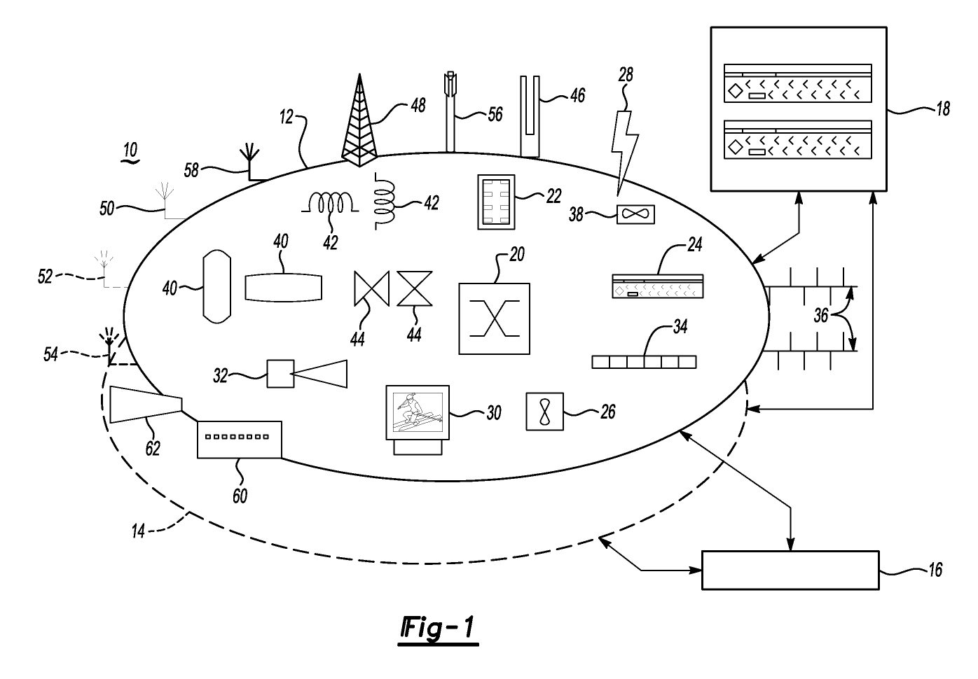

As seen in FIG. 1, the ECCM hardware 10 includes several components including one or more circuit boards 12 and 14, a board selector 16, offboard storage 18, one or more sensors, one or more communication devices, and, optionally, a display unit and/or at least one multi-band antenna.

The ECCM hardware includes at least two circuit boards, a primary circuit board 12 and at least one secondary circuit board 14. While the primary and secondary boards may be different in their components or functionality, preferably the boards are substantially interchangeable with each other. The designations ‘primary’ and ‘secondary’ are relative and reflect only that usually only one board is in use at any given time. The circuit boards are swappable and preferably hot swappable in that a non-functioning board may changed out for a new circuit board without powering down the remaining board or interrupting the operation of the vehicle.

In another embodiment, the boards may operate simultaneously with each board handling a portion of the functionality; for example, one board handles the safety systems while the other board handles the entertainment systems. In another example, one board handles half of each the system or sub-system and the other board handles the remainder of each system or sub-system. Other arrangements of division of labor between the two boards are also contemplated.

The components of the ECCM hardware discussed below that are located on the circuit board may be integrated on to the circuit board as a circuit or they may be connected to the circuit board as a module or through a daughter card.

Each circuit board includes at least one CPU 20. Preferably, each CPU is capable of multithreaded operations, such as multiple core processors. The processor power is selected so that computing tasks for latency intolerant systems can be accomplished without remote computing platforms. A latency intolerant task is one which cannot function properly if there is any delay in the processing results. That is, some computing tasks are not appropriate to offload onto remote computing and storage platforms and so the onboard processor(s) should be sized to handle these tasks.

For example, safety critical systems are latency intolerant because of the limited reaction time required for the system to operate appropriately. Such safety critical systems include brake and accelerator pedal emulation, engine control, electronic steering, brake boost or antilock brakes, enhanced stability control, collision avoidance systems, lane departure warning systems, air bag control systems, and the like. Other examples of latency intolerant systems include the engine control unit (ECU), which requires precise spark timing to function efficiently. Also, playing music and video are relatively latency intolerant, because jitter is an unacceptable part of the user experience.

Latency-tolerant systems function appropriately even with delays, preferably small delays, in processing. Examples include such systems as those used in calculating routes, loading map data, surfing the web, and downloading (but not playing) music or video, logging data on operation of the vehicle, conducting fault analysis on the logged data, or the like.

Each circuit board includes memory such as RAM 22. Similar to the decision about processor power, the amount of RAM will be selected to accommodate safety systems and other latency intolerant tasks.

Each circuit board includes onboard storage 24 such a flash or solid state storage. Only minimal amounts of onboard are needed; just enough to hold bootable operating system software.

Each circuit board includes a watchdog device 26 that monitors the circuit boards for faults. The watchdog device also attempts to store error logs in storage (onboard or offboard) if a fault is detected.

Each circuit board includes a power connection and a ground connection 28; preferably, the power source is the standard 12V power system of an automobile. Standby mode for the power may be implemented through hardware and/or software.

Each circuit board includes a graphics system 30 capable of supporting simultaneous decoding and rendering of multiple graphics streams. For example, the graphics system should be able to simultaneously decode two H.264 1080 p streams while also smoothly rendering multiple low detail 480 p 3D streams and/or medium detail 720 p 3D streams. The graphics system may include its own processor, memory and/or storage.

Each circuit board includes a sound card 32 capable of providing sound to each of the vehicles speakers individually or in combination. Preferably the sound card supports at least four audio-in channels.

The circuit boards may include one or more expansion slots 34 for the addition of hardware to the ECCM. Suitable expansion slots include those readily accessible to the customer such a PC Card (PCMCIA) or ExpressCard slots or USB ports 36. Other ports may be included but are not preferred because most functionality can be provided through the PC Card slot or a USB port. Expansion slots not readily accessible by the customer may also be included on the circuit board such as PCI (and it derivatives) expansion slots.

The ECCM hardware also includes a board selector device 16, whose purpose is to switch between the boards if a fault occurs in one. The board selector may also balance the operation of the boards if both boards are operating.

The ECCM hardware also includes offboard storage 18. Each circuit board has a corresponding disk controller 38. While disk drives of any size or style may be used, redundant solid state storage devices are preferred. For example, use of a RAID array or other disk mirroring is preferred.

The ECCM hardware includes one or more sensors. Preferably, some or all of the sensors are located on the circuit board. Exemplary sensors that maybe include in the ECCM include accelerometers 40, magnetometers 42, tilt sensors 44, barometers, thermometers, etc. For example three axis accelerometers are useful in detecting vehicle acceleration, detecting collisions and improving location determinations (such as GPS). Three axis-magnetometer are useful in detecting magnetic fields and distortions thereto, determining heading and improving location determinations. Tilt sensors are useful in determining a vehicle's orientation relative to flat ground. Some or all of the these sensors may be used in collision avoidance system, range calculation systems and/or stability control systems. Other types of sensors may be used to as sources of vehicle condition information (e.g. tire pressure) or ambient condition information.

The ECCM hardware includes one or more communication devices and preferably multiple communication devices to provide multiple communication channels through which the ECCM hardware can communicate with other systems and sub-systems in the vehicle as well as with devices (e.g. computers) remote from the vehicle. Single or multiple instances of a particular communications device or channel may be used in the ECCM. Preferably, some or all of the communication devices are located on the circuit board. Exemplary communication devices and channels include a CAN bus 46 and similar protocols, cellular communications devices of various types 48 (e.g. 3G, 4G, CDMA, TDMA, etc.), radio tuners 50, digital TV tuners 52, UHF transceivers 54, RF transceivers, satellite communications (e.g. GPS 56 or satellite radio 58), Bluetooth 60, Wi-Fi 60, Wi-Max and the like. Both circuit switching and packet switching types of communication channels are contemplated.

While the CAN bus and its derivatives are preferred for intra-vehicle communications, other protocols may be used such as those compatible with the Onboard Diagnostics-II (OBD-II) standard and/or the J1962 connector.

Cellular communication devices permit the pushing of information from the vehicle such as offloading computational tasks or backing up local storage. Such devices also permit the pulling the information to the vehicle such as streaming live video data, weather data, road conditions, etc. as well as software updates, or new software applications.

RF transceivers may be utilized to communicate with garage door openers or other home automation devices. GPS may be used for navigation and for energy consumption planning purposes. Bluetooth is useful for connecting accessories to the ECCM such as cell phones, wireless headsets and keyless entry systems.

The communications devices and channels, in general, provide the ECCM with redundancy and flexibility. Redundancy is provided so that the ECCM can meet the stability requirements found in safety systems. Likewise, redundancy is useful so that the ECCM can always be in communication with remote computers. Flexibility is provided so that the ECCM can utilize lower cost, faster or more stable communications channels before relying on higher cost, slower or less stable communications channels. Flexibility is also provided so a multitude of entertainment options may be provided to the vehicle.

The ECCM hardware may include one or more input devices such as a trackpad, microphone, an audio jack or a touch screen. One or more of these input devices may be co-located with the ECCM hardware within the vehicle, while other input devices may be separate from the ECCM hardware and yet within the vehicle, such as game controllers for rear seat passengers. In additions, other devices separate or remote from the vehicle may be used as input devices such as portable audio players, smart phones, or the like.

The ECCM hardware may optionally include several, but preferably one, multi-band antenna for receiving communications from the vehicle. In the alternative, the same functionality could be achieved through the use of a network connected transmitter situated close to locus of operation. For example, a networked transmitter for a garage door opener could be located in the garage, rather than with the ECCM hardware on the vehicle.

The system of the present invention preferably includes one or more display devices. The display devices may be separate from the ECCM or preferably at least one display device is co-located with the ECCM hardware. The display devices may provide audio, visual or tactile information to one or more occupants of the car. A single display may be for use of a single occupant, such as the driver's information panel, or a single display may be for use by multiple occupants, such an LCD mounted for viewing by the back seat passengers. Exemplary audio displays include speakers and audio jacks mounted throughout the vehicle. Exemplary visual displays include in-dash displays behind the steering wheel, in dash displays between the driver and passenger, heads-ups displays, in console displays, displays mounted in seat backs or from the headliner. Exemplary tactile displays include vibrating devices designed to alert the driver such as a vibrating steering wheel, seat or gas or brake pedals.

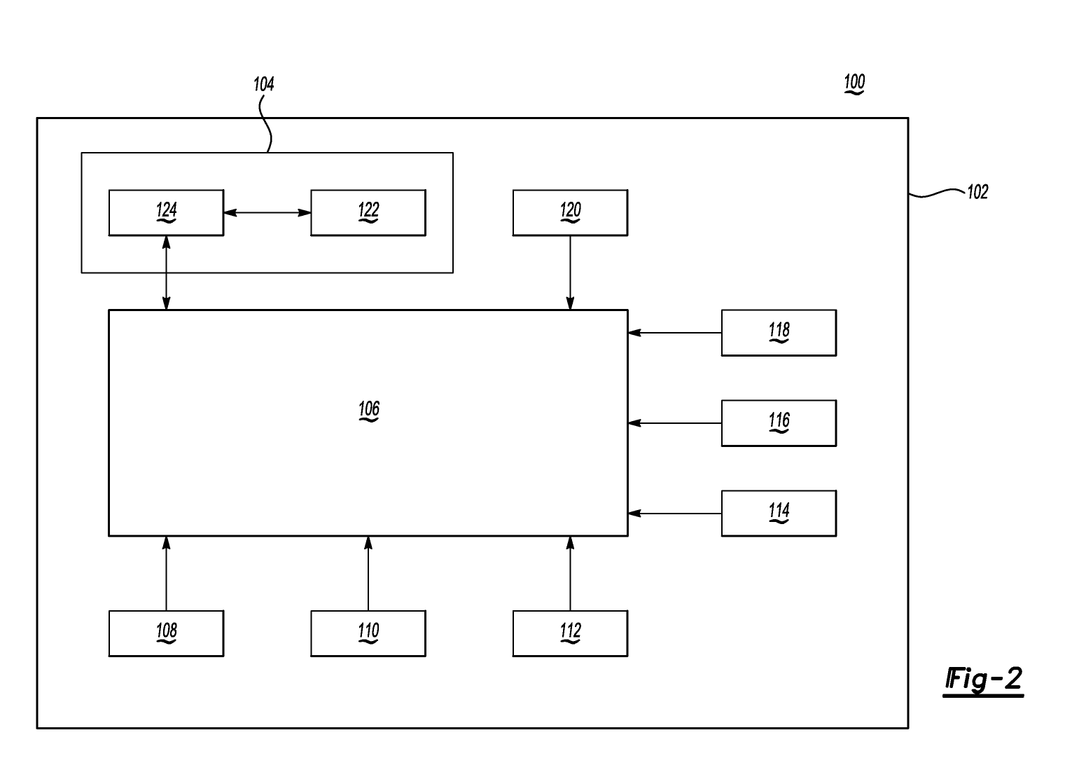

As seen in FIG. 2, the ECCM software 100 includes several components including an operating system 102, an operating system interface (OSI) 104, a user interface 106, one or more computation modules (CM) 108-116, such as an EIM as well as one or more backend systems 118. In one embodiment, the one or more CMs may be supplied through an application store 120 (which itself may be a CM). Typically, the CMs are provided as part of a software package that may also includes audio-visual files, libraries, data files, etc. The one or more backend systems include a user interface builder, a permissions manager, an application programming interface (API), an application store backend, a vehicle layout system, a hardware registration system, or the like.

The operating system software may be any suitable system for use in mobile applications. Preferably, an open source operating system is used to permit the community of interested individuals to extend the capabilities of the ECCM software. For example, a Linux derivative, such a Red Hat Enterprise Linux or its derivative CentOS, is preferred because it supports the CAN Bus through the SocketCAN API and it is widely used so that it is easily upgradeable to add new features or eliminate bugs.

The OSI of the ECCM software includes a plurality of device drivers 122 and a protocol layer 124. Device drivers are typically found within the stock operating system. However, as new hardware or network protocols are developed, new or custom device drivers may be added directly to the kernel of the operating system, as a module to the kernel or at the software level.

The protocol layer of the OSI serves as a translator between the operating system and the rest of the ECCM software. The protocol layer translates all incoming information and communications from the various devices and communications and network protocols into a common format which the user interface and CMs understand. Likewise, the protocol layer translates all outbound information and communications. This serves to reduce the amount of computing power utilized by the user interface and CMs. As the protocol is registered by public function calls, it can be expanded dynamically by CMs.

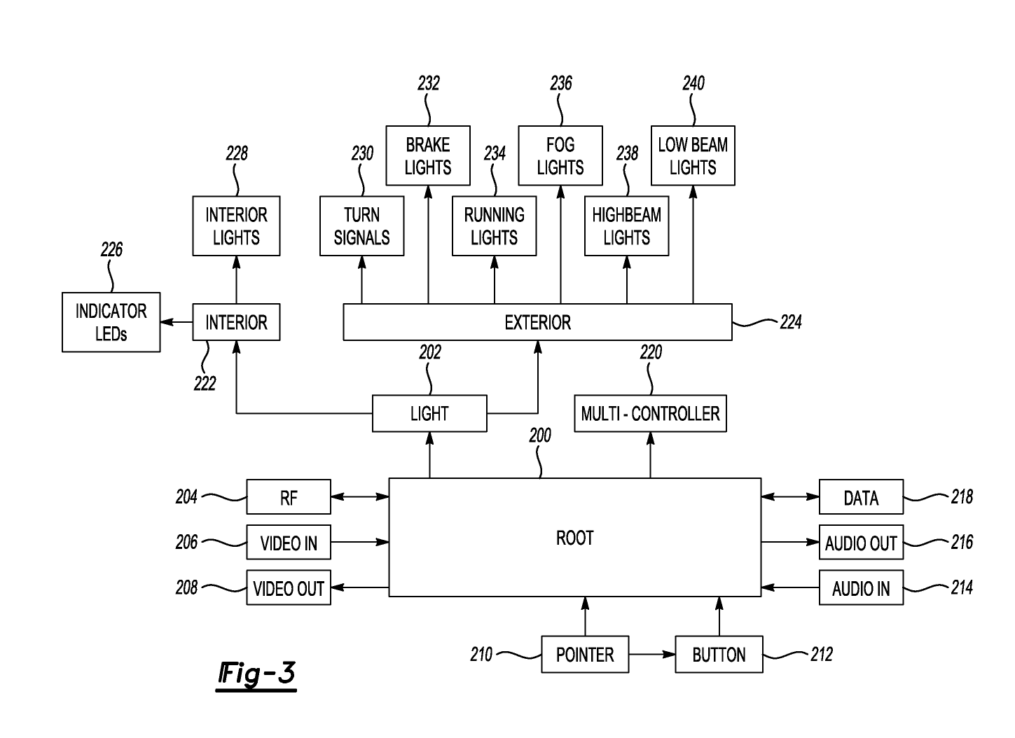

An inheritance diagram for one portion of one embodiment of the protocol layer is shown in FIG. 3.

Root 200 is the base object/event type, from which all other events derive. Higher level functions derive from Root such as Light 202, RF 204, Video In 206, Video Out 208, Pointer 210, Button 212, Audio In 214, Audio Out 216, Data 218, Multi-controller 220, etc.

Below higher level functionality there may be logical categories that further delineate functionalities. For example, the Light 202 functionality may be divided into interior 222 and exterior 224. These logical categories may be further divided. For example, the interior category may be divided into indicator LEDs 226, interior lights 228, etc. while the exterior category may be divided into turn signals 230, brake lights 232, running lights 234, fog lights 236, high beam headlights 238, low beam headlights 240, etc.

Similar inheritance diagrams are used to show the relationship between the higher level functionality and the logical categories of functionalities.

The higher level functionality RF may include logical categories such as Digital RF In and RF Data, which in turn may include garage door opener functionality.

The higher level functionality Video In may include logical categories DVI-In, Digital TV, Component Video In, S-Video In, Composite Video In, Video Player and Camera, etc., with logical category Video Player divided into HDMI-In, Blu-Ray Player and DVD Player. The Camera logical category may include smartphone camera functionality.

The higher level functionality of Video Out may include logical categories Touchscreen, Video Screen, LCD, LED Display, etc.

The higher level functionality of Pointer may include logical categories Mouse, Touchscreen, etc.

The higher level functionality of Button may include logical categories On-Off, Slider, Selector, etc. The ON-Off logical category may in turn include Clutch, Non-Locking Pushbutton, Keyboard, Locking Pushbutton, etc. functionality while the Slider logical category may include Brake, Throttle, Steering Wheel, etc. functionality.

The higher level functionality of Audio In may include logical categories RCA Line-In, TOSLINK In, Radio, Satellite Radio, CD Player, Microphone, Smartphone, etc.

The higher level functionality of Audio out may include logical categories Horn, Speaker, etc.

The higher level functionality of Data may include logical categories Range, Bulk Storage, Sensor, External Charger, etc. The Range logical category may include Radar, Ultrasound, Laser, etc. functionalities. The Bulk Storage logical category may include Disk, Disc reader, etc. functionalities.

The Sensor logical category may include the following functionalities: Rotation Rate (e.g. Crank Sensor, Wheel Speed, etc.), Electronics, Boolean (e.g. Antilock Brake, Door Lock, Alarm Sensor, Seatbelt Latched, Door Open, Gas Cap, Charger Cap, Charger Connected, Gas Connected, Airbag, Parking Brake, etc.), Weather (e.g. Fog Sensor, Light Sensor, Rain Sensor, Iced Glass Sensor, Fogged Glass Sensor, etc.), Voltage (e.g. Battery Voltage, Motor Voltage, Solar Panel Voltage, Charge Port Voltage, etc.), Orientation, Corrosion Detection, Fluids (e.g. Fluid Levels, Fuel Type, Water in Fuel, etc.), Attention Monitoring System, Life (e.g. Battery, Oil Filter, Air Filter, Transmission Fluid, Oil, etc.), Passive (e.g. Fuse, etc.), Transmission Gear, Temperature (e.g. Exterior, Interior, Coolant, Inverter, Engine, Motor, Brake, etc.), Combustion (e.g. Mass Airflow, Oxygen, Ignition, Knock, etc.), Pressure (e.g. Atmospheric Pressure, Manifold Pressure, Brake Pressure, Tire Pressure, etc.), Force (e.g. Torque, Weight, Bumper Force, etc.), Battery State, Current (e.g. Battery Current, Motor Current, Charger Current, Solar Panel Current, etc.), etc.

The Multi-controller logical category may include the following functionalities: Boolean, Brake Pressure, Component Heating (e.g. Defrosting, Heated Mirrors, etc.), Translation (e.g. Seat Position, Headrest Position, Analog Gauge, Sunroof/Moonroof, Power Windows, etc.), Tire Management (e.g. Tire Sealant, Tire Inflation, etc.), Rotation (e.g. Pressure-Limited Rotation, Headlamp Aim, Power Mirrors, Power Doors, Seat Rotation, Headrest Tilt, Backrest Tilt, Seat Tilt, etc.), Heat Management (e.g. Fixed Connections, Standalone HVAC, etc.), Intermittent (e.g. Windshield Wipers, etc.), Alternator, Generator, etc.

The functionalities in the logical categories may be provided by CMs, thus the system is upgradeable through the addition of new functionalities with new CMs. In addition, the system is upgradeable through replacement of old CMs with a newer version. In this manner, the higher level functionalities, the logical categories and the CMs are used to control specific hardware devices.

For the protocol layer to function each piece of hardware (e.g. a video display) and each piece of software (e.g. a CM) is identified with a UID (unique identification). Moreover, as discussed below, each user interface screen and menu is also identified by a UID, as are model objects, value objects and security group objects. UIDs are generally static and are assigned at the time the hardware or software is added to the vehicle, or during the creation of the screens, menus and objects in the user interface builder.

The user interface is the portion of the ECCM software with which the user interacts. In general, the user interface provides information to be displayed on the display devices as well accepting inputs from the user. Displayed information may include information about the condition of the vehicle, ambient weather conditions, road or traffic conditions, as well as entertainment related information. The user interface may be displayed directly on a display device that is part of the vehicle, such through a touch screen, or indirectly, such as played through a Bluetooth headset or on a smartphone connected to the ECCM via Bluetooth or WiFi. The user may interact with the user interface through any device on which it is displayed.

The one or more computation modules (CMs) in the software of the ECCM generally provide functionality to the ECCM. While CMs may provide functionality that is optional, may need upgrading, or is otherwise desirable, CMs may also be used as part of the system. Often provided in combination with other data files, CMs may be binaries, other executable files or libraries that ease the addition of new functionality and ease upgrading of existing functionality, while being able to maintain the security integrity of the ECCM. A CM will be given only as many permissions as needed to carryout its functionality. The use of CMs also increases the extensibility of the ECCM software because third parties can provide CMs through the application store. Such an application store may be the front end that retrieves other CMs from public or private repositories. Public repositories include freely licensed CMs. Private repositories may include freely license CMs or CMs with more limited licenses (e.g. proprietary). For example, in one embodiment, the application store frontend is a CM that operates to permit a user to purchase and/or download to the vehicle CMs for use in the vehicle as part of the ECCM software.

One or more CMs may be pre-installed. These types of CMs typically include those that provide a widely desired functionality such as the EIM (108 in FIG. 2) text-to-speech functionality, speech recognition (110 in FIG. 2), media players (112 in FIG. 2), rendering engines, physics engines, range calculators (114 in FIG. 2), database connectivity (116 in FIG. 2), network connectivity, communications, or the like. Other types of pre-installed CMs include those that control the functionality of hardware or software that is provided by the original equipment manufacturer of the vehicle.

The ECCM interface Manager (EIM) is an event-driven CM in that it waits for the protocol layer or an internal timer to notify it that an event has happened, and that it should respond. The EIM includes multiple CMs that are interconnected and which handle protocol translation, provide functions to add menus, links, buttons, etc.

The pre-installed CMs may be freely licensed or proprietary. For example, a variety of freely licensed packages may be used for text-to-speech such as Festival from Center for Speech Technology Research at the University of Edinburgh. Speech recognition is useful for hands free operation and useful packages include those from IBM licensed under the name ViaVoice Dictation. Numerous media players are available such as MPlayer and VLC Player. Suitable rendering engines include OGRE, while suitable physics engines include Newton Game Dynamics.

Range calculator CMs provide a more accurate determination of how far the vehicle is capable of traveling along a route. While akin to a gas gauge in a traditional vehicle, a range calculator is a more comprehensive analysis of the ambient conditions of the vehicle and its surroundings. A range calculator helps users determine when to refuel or recharge, but also helps the vehicle and its subsystems optimize its power generation and consumption based on the route ahead. The range calculator connects to remote databases to access weather conditions, traffic conditions, road conditions, charging station locations, other geographic data such as road elevation. Since the range calculator connects to remote databases, it preferably also has the ability to offload computation, such through the Amazon EC2 Cloud service. This provides limitless scalability while also providing a way for other CMs to access cloud computing services. One exemplary range calculator that could be used as a CM is the Road2 software from Celadon Applications.

The one or more backend systems 118 include a user interface builder, a permissions manager, an application programming interface (API), an application store backend, a vehicle layout system, a hardware registration system, grid storage, grid computation, or the like.

The backend systems may be local to the vehicle, remote from the vehicle or a combination with some feature onboard the vehicle and some features remotely located. Furthermore, some backend systems may have features hosted on the vehicle and other features hosted remotely. For example, the vehicle manufacturer or system provider may construct the user interface using the user interface builder during vehicle production while the driver may use the user interface builder to apply a skin or theme to the user interface or to set their preferred menu structure. This also highlights that the one or more backend systems may be inaccessible to the vehicle user, accessible to the vehicle user or partially accessible to the vehicle user. That is, some functions may be available to the vehicle user on a limited basis.

The user interface builder has a GUI and permits the construction or modification of the user interface for the vehicle including creating connections between existing hardware and/or software components as well as creating the layout of display screens and menus. The user interface builder uses UIDs to map functionality onto particular pieces of hardware, which have hardware IDs (HIDs). This is referred to as hardware registration. The user interface builder may be a CM where it creates simple pieces of code for interacting with the ECCM, such as through API function calls. The code for the user interface that results from the user interface builder is preferably stored on the ECCM circuit board.

In one example, the operator lays out the hardware components of the ECCM (e.g. accelerometers) or vehicle components connected to ECCM hardware (e.g. speed sensors connected by the CAN bus). Software components (e.g. a range calculator CM) may be added to the user interface. This may be done prospectively as part of the vehicle design process or later after the vehicle design is substantially complete.

In addition, the operator of the user interface builder may also out the screens and menus for the user interface. Construction of menus and screens may include placement of model objects such as buttons, gauges, text, audio, etc. onto screens and menus. For example, within the interface builder, the ECCM hardware components and vehicle components are connected to model objects so that the model objects can display output (e.g. vehicle speed or error messages) from the components. In addition, the ECCM hardware components and vehicle components may be bi-directionally connected to software components to provide inputs for further computations, such that the CMs may provide output to the hardware components. In this manner, the CMs may control the hardware components.

In addition to model objects, value objects may be used, where value objects are hard coded values such as for a hardware device that draws a fixed amount of current. These can be connected to the ECCM hardware and CMs components and vehicle components in the same manner as model objects.

The backend systems also include a permissions manager. The permissions manager may be a stand-alone CM, but preferably it is part of the user interface builder. As the name suggests, the permissions manager manages user accounts and security group objects and manages content permissions of the users to see and use output from ECCM hardware components, CMs and vehicle components and security group objects. Managing user accounts includes creating, changing and deleting user accounts and well as creating, changing and deleting passwords. Default user accounts typically include admin, owner, driver and passenger, while passwords may be text, voice activated, gesture or other access control techniques such as biometric or security token based techniques. Managing security group objects includes creating, changing and deleting security group objects, which are any combination of hardware or CMs classified together for common management of their permissions. For example, changing the permissions on a security group object would propagate the changes down to all the hardware components and CMs in that security group.

Managing content permissions includes granting, changing or revoking a user's ability to change: the content of value objects; the connections between hardware components, CMs and other objects; security group objects, and the code behind CMs. This includes both direct changes—such as through using the user interface builder or the API—and indirect change, such as by installing a CM which performs these actions.

The backend systems also preferably include an API. Because of the modular nature of the ECCM software, the API function calls specify nothing particular to the ECCM hardware components, CMs or vehicle components. The API function calls are primarily about inserting, linking and permissions. The inserting and linking function calls are what the user interface builder and user interface call. The permissions function calls are what the permissions manager calls.

The backend systems also preferably include an application store backend. The application store backend serves at least two functions. First, it provides an intake mechanism for CMs (and be extension, plugins) developed by third parties. Second, it provides a distribution mechanism for CMs (and be extension, plugins) to be supplied to vehicle owners or users.

The intake mechanism allows developers to submit CMs for review before being made available to vehicle owners and users. The formatting of the CM source code is checked as is the ability of the source code to compile. If either of these checks fails, the developer is notified and further evaluation is stopped. After checking formatting and compilation, the CM is checked to determine the level of review that will be required. The types of hardware components, other CMs and vehicle components that will be accessed by the CM will determine the level of review. CMs that access safety critical systems, for example, will require a higher degree of review than CMs that access entertainment systems. The level of review will determine the price of the review presented to the developer. CMs are held in a queue until payment has been made by the developer. After review of a CM is complete, the CM is released and available for purchase or download by vehicle owners or users.

The distribution mechanism of the application store backend is a shopping cart model in which a person with sufficient permissions to install CMs may purchase or download CMs to be automatically installed on the vehicle.

The backend systems also preferably include a vehicle layout system. The vehicle layout system may be a CM or stand alone software. The output of the vehicle layout system may be model objects that can be used in the user interface builder.

In one embodiment, the vehicle layout system provides model objects that give the user a 3D view of the vehicle and components. Such model objects aid the user in visualizing the vehicle, how it is operating, and any system errors.

For example, a powertrain model object may show animated electricity flow from the battery pack to the inverter to the motor, as well as the connection from the motor through the gearbox to the wheels. A climate control model object may show animated coolant and air flow for the battery pack, motor, inverter, and cabin climate control, color-coded for temperature. Diagnostic model objects may show all vehicle parts or systems that have flagged an error in the past 30 days and not yet been repaired or replaced. An ‘everything’ model object may cycles through some or all parts and systems of the vehicle. Solid and wireframe rendering of model objects may be used to distinguish between selected and deselected model objects. At the top of the screen, the current component(s) may be listed, along with their model and a brief description. Clicking on a part brings up a long description and repair/replacement instructions.

The one or more backend systems may include access to grid storage. Grid storage or cloud storage, allows data to be stored not only on the vehicle, but remote from the vehicle as well. A data replication mechanism, which runs in the background, may continually synchronize data on the vehicle to the grid or cloud; for example, via standard S3 transfer protocols. In the alternative, data transfers will only take place the vehicle's onboard storage is sufficiently full (e.g. 90% of the storages is used). The data replication mechanism may include an onboard database to keep track of the last time each file was accessed. When disk space is limited, the least-recently accessed files are synchronized to the cloud. As soon as the transfer is complete, it is replaced on disk with a symlink to a virtual file system, requiring only one sector for storage. When the user tries to access a file that has been moved to grid storage, the file in question is downloaded from the grid and replaces the symlink with the file. Data access will stop until one of two situations is met: 1) The file flagged as a video or music file for which playback can begin with only a partial file present, and enough of the file is downloaded; or 2) The entire file is downloaded.

The net result of this grid storage system is that the user can have all of their files backed up or not, at their choice, and that they have essentially unlimited in-vehicle storage. The cost of the grid storage and data transfers is passed on to the user on their monthly data bill.

The one or more backend system may include access to grid computation. Like grid storage, grid computation (or cloud computation), allows any task that is not time or latency sensitive to be offloaded to remote computers, with the results returned in real-time.

Decisions about where a particular set of computations is handled may be made by the operating system or by the CM that is responsible for the functionality that requires the computations. For example, the operating system may require some CMs to only use grid computation, while other CMs may use on vehicle computing if it the resources are available and off vehicle computing if resources are not available. Any variety of protocols can be used such as ssh or asynchronous HTTP.

Likewise, database operations can be offloaded. The Linux operating system will, by default, include standard client libraries for PostgreSQL and MySQL. This is the approach taken by the Road2™ charging station finder.

In one embodiment, the ECCM operates as follows. As an example, consider playing a video on a Blu-ray player and displaying the video on two video screens over USB. The EIM idles until there is a user request. In response, the EIM requests that a Blu-Ray player with a particular UID play a video. The EIM looks up the HID for that UID and then instructs the protocol layer what command to send to which HID. The protocol layer looks up the network interface for that HID and sends a request to transfer the command. The device drivers send the command over the network, and it is received by the player. The player begins reading the disc and dumping raw data into a stream buffer. As new data comes in, the player compresses and encodes the stream using its private key(s) and the ECCM's public key(s) (the CSS, CPPM, and AACS DRM systems require encryption between playback source and destination). The encoded stream, now in the EIM's preferred format but wrapped in encryption, is sent back over the wire to the ECCM. The protocol layer, listening to the network stream via standard driver API calls, sees the incoming data. The protocol layer decodes the stream using the ECCM's private key(s) and the player's private key(s). Now unwrapped and in the format the EIM expects, the protocol layer passes the data to the EIM, firing an EIM event. The first time the EIM gets the data, it looks up the UIDs of the module(s) which link to the output of the Blu-Ray player's stream. It finds two screens. It then looks up the HIDs for the UIDs. The EIM tells the protocol layer to transfer the stream to the respective HIDs. The protocol layer encodes a copy of the stream using the ECCM's private key(s) and the screen's private key(s). The protocol layer looks up the network interface for each HID and makes standard network (making use of the device drivers) calls to transfer the stream data. The screens receive the data and decode it using their private key(s) and the ECCM's public key(s). The screens play the decoded data and the user is able to watch the video.

Screens connected by HDMI include an additional step. The protocol layer, receiving data from the Blu-Ray player, must itself convert the decoded data stream to the standard format the EIM requires. This is standard for data received over inputs like HDMI. The protocol layer, receiving data from the EIM to send to the screens, must itself convert the EIM-format data to the format required for the screens before encoding and transmission.

For media not restricted by copy control requirements, the protocol layer can skip the encryption encapsulation in its entirety. Different screens may impose other requirements—for example, a low-resolution LCD screen may require down conversion of graphics quality. This may be accomplished by individual CMs or it may be handled by the protocol layer.

Audio transmission works in a similar manner: the device drivers are responsible for talking to the hardware, the protocol layer for translating and encapsulating it, and the EIM for routing. For data transmission and the like, the same procedure is used.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. Plural structural components or steps can be provided by a single integrated structure or step. Alternatively, a single integrated structure or step might be divided into separate plural components or steps. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. As used herein, connected is a broad term that includes physical connections (e.g. wires) and non-physical connections (e.g., wireless signals) as well as the various communications devices, channels and protocols that may be use in making and maintaining the connection between two devices. It should also be appreciated that connected” includes direct connections and indirect connections (e.g., through an additional intermediate device). The present invention also encompasses intermediate and end products resulting from the practice of the methods herein. The use of “comprising” or “including” also contemplates embodiments that “consist essentially of” or “consist of” the recited feature.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

What is claimed is:

1. A system for controlling a motor vehicle, comprising:
a plurality of vehicle components;
an electronic communication and control module (ECCM) comprising hardware and software, wherein in the ECCM includes hardware and software having a modular design, redundant functionality and that is upgradeable and wherein the ECCM is connected to the plurality of vehicle components and connectable to a remote computing resources; and
at least one display unit connected to the ECCM.

2. The system of claim 1 wherein the hardware of the ECCM further comprises at least two, hot swappable circuit boards.

3. The system of claim 1 wherein the plurality of vehicle components include one or more latency intolerant systems.

4. The system of claim 3 wherein the plurality of vehicle components include one or more latency tolerant systems.

5. The system of claim 4 wherein the ECCM communicates with the remote computing resources to accomplishing computing or storage for the one or more latency tolerant systems.

6. The system of claim 5 wherein the software of the ECCM further comprises a protocol layer separating an operating system from the remainder of the software of the ECCM.

7. The system of claim 6 wherein the software of the ECCM further comprises one or more computation modules that provide upgraded functionality to the software.

8. The system of claim 7 wherein the one or more computation modules comprises at least a frontend of an application store through which additional computational modules may be added to the software.

9. The system of claim 8 wherein at least a backend of the application store is found on the remote computing resources.

10. An electronic communications and control module, comprising:
hardware including a plurality of identical, hot-swappable, circuit boards and one or more communication devices; and
software including a protocol layer situated between one or more device drivers and the remainder of the software,
wherein the hardware and software 1) cooperate to facilitate operation of a motor vehicle by using the protocol layer to translate between the device drivers and the remainder of the software; 2) are upgradeable; and 3) off load computation or storage for one or more vehicle components onto remote computing resources.

11. The module of claim 10 further connected to a display device in the motor vehicle.

12. The module of claim 11 wherein the software further comprises one or more computation modules.

13. The module of claim 12 wherein the one or more computation modules comprises at least a frontend for an application store.

14. The module of claim 13 further comprising remote computing resources.

15. The module of claim 12 wherein the one or more computation modules comprises a range calculator.

16. The module of claim 15 further comprising remote computing resources.
